(19) United States
(12) Patent Application Publication
(10) Pub. No.: US 2008/0230634 A1
(43) Pub. Date: Sep. 25, 2008

(54) Showerhead dispensing nozzle

(75) Inventor: Alan T. Ziegler, Santa Cruz, CA (US)

Correspondence Address: Lawrence Edelman;Attorney at Law, The Law Office of Lawrence Edelman, 130 San Aleso Avenue, San Francisco, CA, 94127, US

(73) Assignee: Cryotech International

(21) Appl. No.: 11/713,239

(22) Filed: Mar. 2, 2007

(51) Int. Cl. B05B 1/26

(52) U.S. Cl. 239/533.1; 239/461

(57) ABSTRACT

A injector nozzle for a cryogenic fluid wherein both the kinetic energy of the discharge stream, and the residual volume of cryogenic fluid contained within the nozzle is reduced, the dispensing nozzle of a generally showerhead type configuration, with discharge ports disposed at the periphery of the showerhead discharge face, and a filler member disposed internal to the showerhead assembly, to reduce the volume of the conical chamber immediately upstream of said discharge faceplate.

### BACKGROUND OF THE INVENTION

1. Field of the Invention

The present invention relates generally to cryogenic liquid delivery systems and, more particularly to a managed dosing system for injecting metered droplets of liquid nitrogen into beverage, food or other product containers as they move along high-speed production lines before being sealed. In particular, it relates to a dispensing nozzle of unique design which accurately delivers a measured dose of liquid nitrogen as a dispersed stream of reduced kinetic energy.

2. Description of the Related Art

With thin walled containers, especially thin walled metal cans and plastic bottles, it has been found useful to stiffen them after filling, but prior to further processing, such as labeling, shipping and handling to prevent subsequent container damage. To achieve such stiffening, a liquid cryogen such as nitrogen may be injected just prior to sealing. Injected as droplets, the liquid cryogen undergoes a phase change to a gas, increasing the pressure inside the sealed container, the increased pressure acting to stiffen the container walls.

Typically, the liquid cryogen drops or droplets, once injected, will coalesce as they sit on the contents, the vaporization process taking anywhere from 5-15 seconds. Accordingly, the time between injection and container closure must be kept short. It is to be appreciated the exact time of vaporization is dependent upon the size of the injected droplet, and the temperature of the container contents. The resulting pressure within the container will similarly be a function of the size of the injected drop, the free space to be filled, and the time between droplet injection and container closure.

In commercial applications, specialized liquid nitrogen delivery systems have been developed for injection of small amounts of nitrogen into containers as they pass along an assembly line. Such systems are sold by VBS Industries of Campbell, Calif. (now Cryotech, International), under the trade names LCI-300, 400, and 2000M. See also U.S. Pat. No. 6,182,715 to Alex R. Ziegler, et al, which patent is incorporated herein by reference in its entirety, as well as copending application US2005/0011580 A1.

In these systems, a stream of liquid cryogen droplets is dispensed vertically into a moving container. One such type of nozzle used in the past is shown in FIG. 1, item 108 of application US2005/0011580 A1. With such an injector nozzle having a singular opening, however, it was found that the force of injection caused the droplets to substantially penetrate the surface of the container contents. These high impact forces can result in splash-back of the contents onto the dosing head, where the splashed liquid may accumulate and later interfere with the operation of the dosing head itself.

Conveyer systems are run at fairly high speeds where containers pass by fixed stations at the rate of 500 units per minute or more. In fact, some processing conveyor lines run to speeds in excess of 1500 to 2000 containers per minute. At lower speeds, e.g. 500 units per minute, the liquid nitrogen feed systems of the referenced prior art perform well. However, at higher line speeds, the dispensing assemblies must operate at higher frequencies. With such high speed lines where containers pass a fill point at the rate of upwards of 1000 to 2000 units per minute, the residence time at the liquid injection station also becomes a factor, with the time allowed for fill becoming shorter than the time required for delivery of the dispensed liquid dose stream. This mismatch, in combination with high impact forces, can result in a good portion of the injected dose missing the container opening, and thus lost to the atmosphere by vaporization. As a further result, maintenance of dose accuracy and repeatability can be lost.

One approach has been to employ a shower head delivery nozzle of the type depicted in FIG. 1, and which is more fully described hereafter, for the injection of the liquid cryogen. With reference to the figure, a shower head dispensing nozzle (i.e. injector) 100 is illustrated which includes a threaded body portion 105, valve seat 102, valve throat 106, inverted conical chamber 110, and shower head face plate 112. Valve seat 102 is configured to receive sealing stem 104, which stem is rapidly opened and closed to meter a measured amount of cryogen to the dispensing nozzle. A more complete description of the operation of the dosing head and sealing stem can be found in my copending application US 2005/0011580A1. Cryogen dispensed to the nozzle enters the conical chamber 110 and is discharged through a plurality of discharge openings 114 peripherally disposed in face plate 112.

By distributing the measured cryogen stream over a wide area, the kinetic energy of the injected dose is reduced [compared to size of single opening of nozzle shown in FIG. 1 of the copending application], thus reducing the amount of splashback. However, it has been found with this shower head configuration, the to-be-injected dose is not immediately discharged, with a substantial residual volume of the cryogen remaining in the nozzle chamber 110 behind face plate 112. This retained volume tends to drain itself over a time period in the order of about one half second (or more). However, in the process of high speed container filling, during this time interval the container being dosed will have been displaced from its fill position, resulting in some of the dose, i.e. the residual drips, falling outside of the container, either onto the sides of the container, the conveyor line, or even possibly onto the next, oncoming container. This inconsistent dosing can lead to inconsistent pressures within the containers being filled. Thus there remains a need to accurately dose a cryogenic liquid into a container, while reducing and preferably eliminating cryogenic liquid splash back, and spill over onto and into an oncoming container.

### SUMMARY OF THE INVENTION

By way of this invention a unique shower head type of dispensing nozzle is provide having a generally inverted conical configuration, the dispensing nozzle including a nozzle body, and an intake passageway disposed within the nozzle body. At a first end, the said intake passageway is in fluid communication with a valve seat. At its other end, said passageway is in fluid communication with an inverted conical chamber, the chamber further defined at its base by a discharge face plate. A plurality of openings provided in said face plate are arranged around the perimeter of said plate. In addition, a filler member or post integral to the back side of the face plate is provided to reduce the residual (i.e. void) volume within the conical chamber of the nozzle. By this configuration, the dripping problem caused by the slow release of the residual cryogenic fluid existing with the prior art shower head dispenser is reduced.

### BRIEF DESCRIPTION OF THE DRAWINGS

So that the above-recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a three dimensional cross sectioned view of a traditional shower head injector nozzle of the prior art.

FIG. 2 is a three dimensional cross sectioned view of an embodiment of the shower head dispensing nozzle of the present invention.

FIG. 3 is a three dimensional view of the injector nozzle of FIG. 2 rotated to display the face plate of the nozzle.

FIG. 4 is a cross sectional view of a typical injection head assembly for the dispensing of cryogen, including the injector nozzle of this invention.

### DETAILED DESCRIPTION OF THE INVENTION

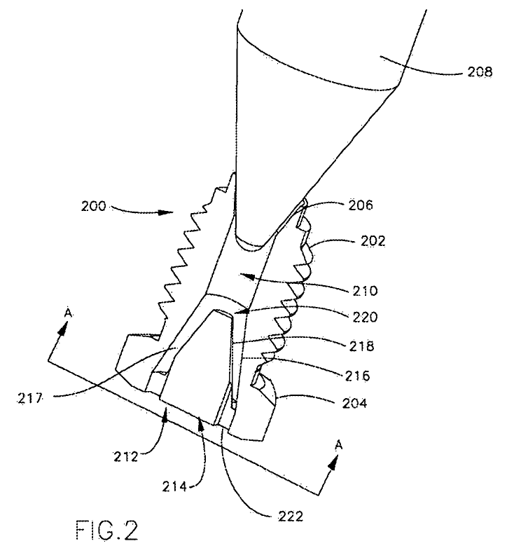

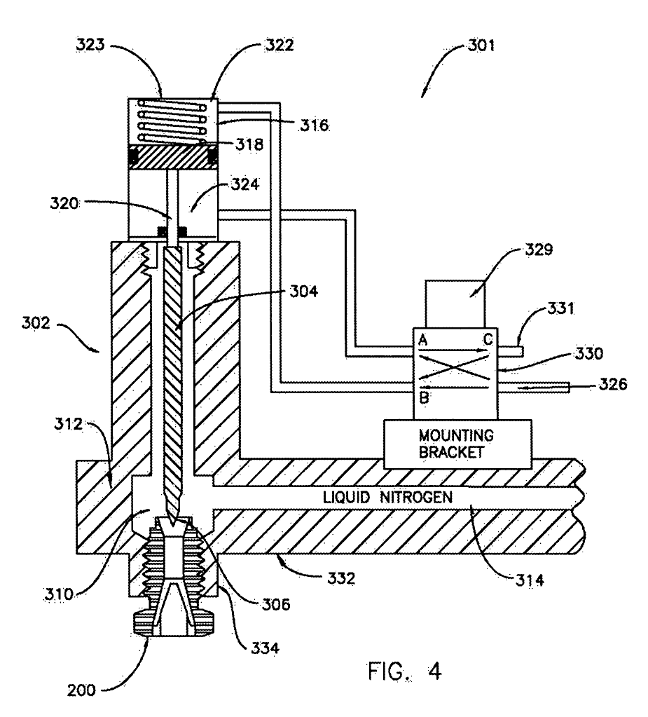

The shower head injector nozzle 200 of this invention is depicted in FIG. 2, the injector nozzle including threaded body 202, valve seat 206 and a shower head dispensing portion 212. Threaded body 202 is sized so as to be received by the internal threads of the dosing head to which it is to be engaged. Valve seat 206, positioned at one end of injector 200, is sized to receive the sealing stem 208 of a dosing head (later to be described in connection with FIG. 4). Intake passageway 210 is in fluid communication with valve seat 206 and conical chamber 220, providing a continuous path for the flow for liquid cryogen from the cryogen source through the injector nozzle to the container to be filled. The threaded lower end of injector 200 terminates as hexagonal bolt head 204, bolt head 204 provided to facilitate threading of the injector nozzle into the dosing head.

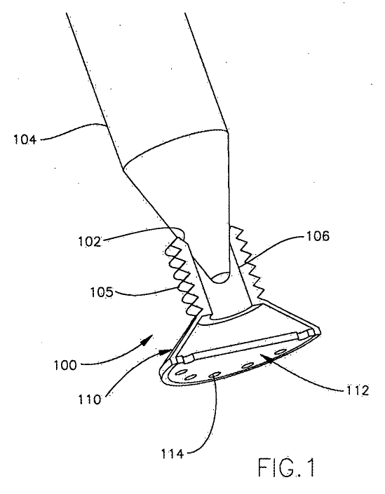

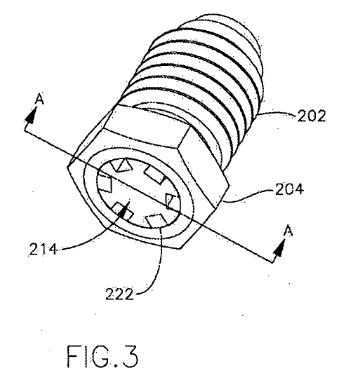

Shower head dispensing portion 212 includes discharge face plate 214, the face plate having inwardly and outwardly facing surfaces. The back (i.e. the inwardly facing surface) of discharge face plate 214 includes a filler member or post such as an inverted cone or plug 218 which may or may not be solid. A plurality of nozzle openings 222 are provided around the periphery of face plate 214 communicating between said inwardly and outwardly facing surfaces) to allow for the discharge of liquid cryogen from the nozzle. The shape of the openings is not critical. In one embodiment, they may be circular, as shown in FIG. 1. In another embodiment, the may be square as shown in FIG. 3. In the latter case, the square openings provide a greater open area compared to circular openings of the same diameter, the larger surface area serving to further reduce the kinetic energy of the discharged liquid cryogenic stream.

The number of openings 222 is not critical. However, the combined cross sectional area of the openings provided should be at least the same, if not more than the cross-sectional area of intake passageway 210. Further, if too many openings are provided, such that the distance between openings is reduced, a tenancy has been observed for liquid streams to recombine. Thus, it is preferred the face plate have fewer, but larger openings so as to maintain a minimum distance between openings. By way of example, for a shower head face plate 214 of a diameter of 5-6 mm, the minimum distance between nozzle openings at typical cryogenic liquid pressures of 0.5 PSI can vary from between 1 mm and 3 mm, and is optimally about 2 mm.

Filler member 218 extends upwardly from face plate 214 towards intake passageway 210. As shown in FIG. 2, filler member 218 may extend close to but not into passageway 210. In various embodiments, member 218 can extend a limited distance into passageway 210. In still further embodiments, member 218 can be a cone, a cone like frustum (as illustrated in the figure), or a post.

Interior, conical chamber 220 is defined by sloping, diverging wall 216 of body 202. An annular passageway 217 is defined between walls 216 of body 202 and the sloped wall of filler member 218. In general, the slope of the wall of member 218 is greater than the slop of opposing wall 216, whereby the spacing between these opposing walls increases moving longitudinally in the direction towards intake passageway 210. At a minimum, the difference in slope of the walls is selected such that the cross sectional area of annular passageway 217 remains constant in the direction of fluid flow.

In one embodiment, the slope of these opposing walls is adjusted such that the cross sectional area of passageway 217 increases in the direction of fluid flow. In other embodiment the cross sectional area of said passageway decreases, moving in the direction of fluid flow towards discharge face plate 214. Further, the ratio of the cross sectional area of the annular passageway relative to the cross sectional area of the connecting intake passageway can vary from 0.5 to 1.5. The smaller the ratio, the greater is the kinetic energy of the flow exiting nozzle openings 222, the larger the ratio, the lower is the kinetic energy of the exiting flow. It another embodiment, it is preferred to maintain close to laminar flow in annular passageway 217, the above ratios consistent with near laminar flow conditions.

The materials of construction for the injector nozzle are not critical, but must take into account the discharge head with which it is to be used. Most importantly, the thermal expansion properties of the shower head nozzle should be matched to that of the dispensing unit into which it will be affixed. Preferably the materials used to construct the nozzle and dispensing unit will have the same thermal coefficient of expansion. Typically, the nozzle will be formed of stainless steel to match the stainless steel used with the dispensing unit.

With reference now to FIG. 4, shower head injector 200 is shown in combination with a typical dosing head assembly 301 sold by Cryotech International, whereby droplets of liquid nitrogen are metered from a dosing head 302. The dosing head 302 includes a needle valve system for dispensing of the liquid nitrogen, the needle valve including a valve sealing stem 304, with valve head 306 at its distal end, the valve head 306 sized for sealable engagement with valve seat 206 of the shower head injector 200. Reservoir 310 defined by valve body 312 acts as a local liquid cryogen supply chamber for holding liquid cryogen, inundating the seating area of the needle valve. Liquid nitrogen is fed to reservoir 310 through source conduit 314, extending from flexible dosing arm 332. It is contained in chamber 310 at slightly elevated pressure, e.g. 1 PSI above atmospheric. In a passive system, the pressure is created by the hydrostatic head of a larger cryogen source reservoir (not shown) placed above and supplying conduit 314. This liquid nitrogen supply may be pressurized, if desired. Typical pressures can range from near zero to 10 psi above atmosphere, with 6 psi being a customary upper limit. With the valve open, liquid nitrogen will flow through the metering orifice of valve seat 206, the flow interrupted when the valve is closed.

In order to precisely meter the amount of nitrogen dispensed into each container, it is important to be able to quickly open and close the dosing valve. This is achieved with a pneumatic actuator of the type shown in FIG. 4. Therein, and by way of illustration, valve stem 304 is secured at its proximate end to the end of a pneumatically actuated piston 316. The piston includes a piston head 318, a stem 320, upper and lower chambers 322 and 324, and ports for sequentially injecting and exhausting a gas such as nitrogen into both the upper and lower chambers to cause movement of the piston either upwardly or downwardly, in turn moving the needle valve to either the open or closed position.

The actuator may be spring loaded to bias the valve to the closed position. With the valve open as shown in FIG. 4, the lower chamber 324 of the pneumatic piston is pressurized, the upper chamber exhausted to atmosphere via vent 331. To lower valve head 306 and thus close the valve, upper chamber 322 is pressurized by flowing gas into that chamber, while the lower chamber is exhausted to atmosphere.

To effectuate such rapid opening and closing, the piston is driven by a 4-way solenoid valve 330 which controls the flow of nitrogen gas to the chambers above and below the piston head. As shown in the FIG. 4, this valve is separately mounted on dosing arm 332, some distance from the liquid nitrogen dispensing valve. In the mode illustrated, a pressurized source of nitrogen (or other inert gas) is supplied via supply line 326, the 4-way valve 330 biased in the closed position. When opened, the gas flows through the solenoid actuated valve to one of the piston chambers, to cause either opening or closing of the needle valve. The operation of the solenoid is controlled by a controller, not shown, which can be programmed to adjust valve cycle time, and thus control dose settings.

In the case of the injector nozzle of this invention, the liquid cryogen dispenses during the time that the sealing stem is raised and the needle valve is thus in the open condition. The dispensed cryogen first enters intake passageway 210, and then into annular passageway 217 where the velocity of the stream slows before it is discharged through openings 222. The effect of thus reducing the kinetic energy of the discharge stream is achieved. With the reduction in the volume of conical chamber 220 due to the presence of filler cone member 218, the amount of residual cryogen remaining in the chamber after closure of the needle valve is greatly reduced, and thus the degree of latent drip of cryogen onto the sides of the container being filled, the conveyor belt and possibly onto the next container to be filled is significantly reduced.

While the foregoing is directed to embodiments of the present invention, other and further embodiments of the invention may be devised without departing from the basic scope thereof, and the scope thereof is determined by the claims that follow.

1. An injector nozzle for discharging a cryogenic liquid, including:
a nozzle body;
an intake passageway disposed within said nozzle body, said passageway of a determined cross section;
an inverted conical chamber disposed in fluid communication with said intake passageway;
a discharge face plate disposed at the base of the inverted conical chamber, said face plate including an inwardly facing surface and an outwardly facing surface;
a plurality of openings in said discharge faceplate extending between said inwardly and outwardly facing surfaces to provide a fluid path from said conical chamber for discharge of cryogenic liquid; and,
a filler member which defines said inner facing surface, and extends from the base of and into said inverted conical chamber, to thus reduce the void volume of said conical chamber.

2. The nozzle of claim 1 further including a valve seat disposed immediately upstream of and in fluid communication with said intake passageway.

3. The nozzle of claim 1 wherein the openings in said discharge faceplate are round openings.

4. The nozzle of claim 1 wherein the openings in said discharge faceplate are square openings.

5. The nozzle of claim 1 wherein the filler member is an inverted cone.

6. The nozzle of claim 4 wherein the filler member is an inverted conical frustum.

7. The nozzle of claim 5 wherein the walls of the inverted cone are of greater slope than the walls of the conical chamber, whereby an annular passageway between said walls is defined, said passageway of constant total cross sectional area in the direction of fluid flow.

8. The nozzle of claim 7 where the ratio of the cross section of the intake passageway to said annular passageway is from 0.5 to 1.5.

9. The nozzle of claim 1 wherein the openings are spaced one from the other to prevent cryogenic stream recombination.

10. The nozzle of claim 1 wherein the openings in said discharge faceplate are arranged along the periphery of said faceplate.

11. The nozzle of claim 1 wherein said nozzle body is provided with external threads to permit it to be threaded into a liquid cryogen dispensing unit.

12. The nozzle of claim 12 in which the nozzle body is terminated at it discharge end by a bolt like head, said bolt like head surrounding said discharge faceplate.

13. In combination, the nozzle of claim 2 with a liquid cryogen dispensing head for, said dispensing head including a local fluid reservoir, a needle valve, means for actuating said needle valve to permit fluid communication between said reservoir and said nozzle, said needle valve positioned to sealingly engage the valve seat of said injector nozzle when the value is in the closed position.
